(19) United States
(12) Patent Application Publication
(10) Pub. No.: US 2014/0265554 A1
(43) Pub. Date: Sep. 18, 2014

(54) Dual Lithium-Ion Battery System for Electric Vehicles

(71) Applicant: FORD GLOBAL TECHNOLOGIES, LLC, Dearborn, MI (US)

(72) Inventors: Xiao Guang Yang, Northville, MI (US); Renata Michaela Arsenault, Plymouth, MI (US); Richard Dyche Anderson, Plymouth, MI (US)

(73) Assignee: FORD GLOBAL TECHNOLOGIES, LLC, Dearborn, MI (US)

(21) Appl. No.: 13/829,148

(22) Filed: Mar. 14, 2013

(51) Int. Cl. B60L 11/18

(52) U.S. Cl. CPC B60L 11/1861
USPC 307/9.1

(57) ABSTRACT

A battery system for powering a vehicle is provided. The system may include a first lithium-ion battery pack having a first total energy capacity and a first power to energy ratio (P/E ratio) and a second lithium-ion battery pack connected in parallel with the first lithium-ion battery pack and having a second total energy capacity that is higher than the first total energy capacity and a second P/E ratio that is lower than the first P/E ratio. A method of controlling the battery system is also provided, and may include controlling an operation of a vehicle according to a total power capability of the first and second battery strings, wherein the total power capability is the sum of a first battery string power capability and a second battery string power capability at a same voltage.

### TECHNICAL FIELD

One or more embodiments relate to a battery system having multiple lithium-ion batteries.

### BACKGROUND

The term “electric vehicle” as used herein, includes vehicles having an electric motor for vehicle propulsion, such as battery electric vehicles (BEV), hybrid electric vehicles (HEV), and plug-in hybrid electric vehicles (PHEV). A BEV includes an electric motor, wherein the energy source for the motor is a battery that is re-chargeable from an external electric grid. In a BEV, the battery is the source of energy for vehicle propulsion. A HEV includes an internal combustion engine and an electric motor, wherein the energy source for the engine is fuel and the energy source for the motor is a battery. In a HEV, the engine is the main source of energy for vehicle propulsion with the battery providing supplemental energy for vehicle propulsion (the battery buffers fuel energy and recovers kinematic energy in electric form). A PHEV is like a HEV, but the PHEV has a larger capacity battery that is rechargeable from the external electric grid. In a PHEV, the battery is the main source of energy for vehicle propulsion until the battery depletes to a low energy level, at which time the PHEV operates like a HEV for vehicle propulsion.

A major concern of consumers for batteries in plug-in hybrids and electric vehicles is ‘range anxiety,’ or the electric driving range per charge. However, other major concerns of manufacturers include calendar/cycling life, low temperature performance, safety, and cost. The result of balancing these concerns results in battery manufacturers generally compromising the cell design to achieve increased power capability at the expense of reduced energy density of the battery. This translates to reduced driving range per charge, lower abuse tolerance, and higher cell costs.

### SUMMARY

In at least one embodiment, a battery system for powering a vehicle is provided. The system comprises a first lithium-ion battery pack having a first total energy capacity and a first power to energy ratio (P/E ratio) and a second lithium-ion battery pack connected in parallel with the first lithium-ion battery pack and having a second total energy capacity that is higher than the first total energy capacity and a second P/E ratio that is lower than the first P/E ratio. At least one controller is programmed to control the first and second lithium-ion battery packs.

In at least one embodiment, a method for operating a vehicle is provided. The method comprises receiving in a vehicle controller information corresponding to limiting voltages of a first and a second lithium-ion battery string, each battery string having different total energy capacity. It further includes controlling an operation of the vehicle according to a total power capability of the first and second battery strings. The total power capability is the sum of a first battery string power capability and a second battery string power capability at a same voltage.

### BRIEF DESCRIPTION OF THE DRAWINGS

FIG. 1 is a schematic diagram of a vehicle system having a dual battery system according to one or more embodiments;

FIG. 2A is a graph illustrating a vehicle requested total power according to one or more embodiments;

FIG. 2B is a graph illustrating a portion of the total power of FIG. 2A provided by a high-power battery pack according to an embodiment of the dual battery system of FIG. 1;

FIG. 2C is a graph illustrating a portion of the total power of FIG. 2A provided by a high-energy battery pack according to an embodiment of the dual battery system of FIG. 1;

FIG. 3 is a cross-section of a lithium-ion battery cell according to one or more embodiments;

FIG. 4 is a schematic of a controls architecture for use with the battery system of FIG. 1; and

FIG. 5 shows an embodiment of an algorithm for determining a power capability of the battery system.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

A lithium-ion battery (Li-ion battery) typically includes an anode, cathode and electrolyte. Lithium ions move from the anode to the cathode during discharge and from the cathode to the anode during charge. Lithium-ion batteries may be electrically connected in series to form a battery pack for an automotive vehicle. Power from such a battery pack may be used to generate motive power, via an electric machine, to move the vehicle.

With reference to FIG. 1, a battery system for powering a vehicle is illustrated in accordance with one or more embodiments and is generally referenced by numeral 10. The battery system 10 is depicted within a vehicle 12. The battery system includes a first Li-ion battery pack 14 and a second Li-ion battery pack 16 electrically connected in parallel. The first and second Li-ion battery packs 14, 16 are controlled by a battery energy control module (BECM) 18. There may optionally be a second BECM 20 that is either co-equal with the first BECM 18, and each controls one of the battery packs 14, 16, or the second BECM 20 may work with the BECM 18 in a master/slave relationship in which the two BECMs are connected with a private communications network (e.g. CAN). The vehicle 12 includes a charger 22, a motor 24, and a generator 26, each connected to the battery system 10.

The illustrated embodiment depicts the vehicle 12 as a battery electric vehicle (BEV), which is an all-electric vehicle propelled by an electric motor 24 without assistance from an internal combustion engine (not shown). The motor 24 receives electrical power and provides drive torque for vehicle propulsion. The motor 24 may also function as a generator 26 for converting mechanical power into electrical power through regenerative braking. The vehicle 12 has a transmission (not shown) that includes the motor 24 and a gearbox (not shown). The gearbox adjusts the drive torque and speed of the motor 24 by a predetermined gear ratio. A pair of half-shafts extend in opposing directions from the gearbox to a pair of driven wheels (not shown). In one or more embodiments, a differential (not shown) interconnects the gearbox to the half-shafts.

Although illustrated and described in the context of a BEV 12, it is understood that embodiments of the present application may be implemented on other types of electric vehicles, such as those powered by an internal combustion engine in addition to one or more electric machines (e.g., hybrid electric vehicles (HEVs) and plug-in electric vehicles (PHEVs), etc.).

The vehicle 12 includes a charger 22 for charging the battery packs 14, 16. An electrical connector connects the charger 22 to an external power supply (not shown) for receiving AC power. Other embodiments of the charger 22 contemplate an electrical connector that couples to an external charge port for facilitating inductive charging (not shown). The charger 22 includes power electronics used to invert, or “rectify” the AC power received from the external power supply to DC power for charging the batteries 14, 16. The charger 22 is configured to accommodate one or more conventional voltage sources from the external power supply (e.g., 110 volt, 220 volt, etc.). In other embodiments, the charger 22 may be located outside the vehicle 12 and may provide DC power to the vehicle 12 to charge the batteries 14, 16. The external power supply may include a device that harnesses renewable energy, such as a photovoltaic (PV) solar panel, or a wind turbine (not shown). In some embodiments, one or both of the batteries 14, 16 may have a separate set of contactors for charging (not shown).

The BECM 18 (or 18 and 20) can maintain a balance or relative equilibrium in the state of charge (“SOC”) among the cells of the battery packs 14, 16. Cell balancing can be accomplished, for example, by transferring energy from one cell to another, or by dissipating energy in the cells such that they all achieve a common voltage before subsequently charging them. During cell balancing or normal discharge of the cells, a minimum SOC in the cells can be reached. At their minimum SOC, the cells are at approximately their minimum allowable charge as dictated by the BECM 18 in which the BECM 18 commands cell balancing or recharging of the cells. The BECM 18 can also dictate and control the SOC of the battery packs 14, 16 such that the battery packs 14, 16 as a whole similarly define a minimum SOC.

In at least one embodiment, the first Li-ion battery pack 14 is a “high-power” battery pack (HPBP) capable of providing a majority of the transient power demand of the vehicle 12 for acceleration. In one embodiment, the HPBP 14 has a nominal power capability of at least 50 kW. In another embodiment, it has a nominal power capability of at least 75 kW. In another embodiment, it has a nominal power capability of at least 100 kW. In another embodiment, it has a nominal power capability of at least 110 kW. In another embodiment, it has a nominal power capability of at least 120 kW.

The high-power battery pack 14 therefore has a relatively high power to energy ratio (P/E ratio). In one embodiment, the HPBP 14 has a P/E ratio of at least 10 kW/kWh. In another embodiment, it has a P/E ratio of at least 15 kW/kWh. In another embodiment, it has a P/E ratio of at least 20 kW/kWh. In another embodiment, it has a P/E ratio of at least 25 kW/kWh. The power/energy ratios referred to provide are calculated using 10 second discharge power and total on-board energy of a given battery pack.

In at least one embodiment, the high-power battery pack 14 provides over half of the electric transient power demand of the vehicle for acceleration. In one embodiment, the high-power battery pack 14 provides at least 70% of the electric transient power demand for acceleration. In another embodiment, the high-power battery pack 14 provides at least 80% of the electric transient power demand for acceleration. In another embodiment, the high-power battery pack 14 provides at least 90% of the electric transient power demand for acceleration. In another embodiment, the high-power battery pack 14 provides at least 95% of the electric transient power demand for acceleration. In another embodiment, the high-power battery pack 14 provides substantially all of the electric transient power demand for acceleration.

In at least one embodiment, the second Li-ion battery pack 16 is a “high-energy” battery pack (HEBP) capable of providing the main on-board storage energy source and determining the driving range per charge of the electric vehicle 12. In one embodiment, the HEPB 16 has a total energy capacity of at least 5 kWh. In another embodiment, the HEPB 16 has a total energy capacity of at least 10 kWh. In another embodiment, the HEPB 16 has a total energy capacity of at least 20 kWh. In another embodiment, the HEPB 16 has a total energy capacity of at least 30 kWh. In another embodiment, the HEPB 16 has a total energy capacity of at least 40 kWh. In another embodiment, the HEPB 16 has a total energy capacity of at least 50 kWh. In another embodiment, it has an energy capacity of at least 75 kWh. In another embodiment, it has an energy capacity of at least 100 kWh. In another embodiment, it has an energy capacity of at least 125 kWh. In one embodiment, the HEBP 16 has a total energy capacity of between 10 to 125 kWh. In another embodiment, the HEPB 16 has a total energy capacity between 25 to 125 kWh. In another embodiment, the HEPB 16 has a total energy capacity between 50 to 125 kWh. In another embodiment, the HEPB 16 has a total energy capacity between 75 to 125 kWh.

Due to the high-power battery pack 14 providing a majority of the high-power capability, the high-energy battery pack 16 may have a significantly reduced P/E ratio compared to conventional electric vehicle batteries and to the high-power battery pack 14. In one embodiment, the P/E ratio is at most 10 kW/kWh. In another embodiment, the P/E ratio is at most 5 kW/kWh. In another embodiment, the P/E ratio is at most 3 kW/kWh. In another embodiment, the P/E ratio is at most 2 kW/kWh. In another embodiment, the P/E ratio is at most 1 kW/kWh.

As a result of the reduced power requirements, the high-energy battery pack 16 can be designed to have an increased specific energy density compared to conventional electric vehicle batteries. For example, a conventional electric vehicle battery may have a specific energy of about 120 watt-hours per kilogram (Wh/kg). However, in at least one embodiment, the high-energy battery pack 16 may have a specific energy density of at least 175 Wh/kg. In another embodiment, the high-energy battery pack 16 may have a specific energy density of at least 200 Wh/kg. In another embodiment, the high-energy battery pack 16 may have a specific energy density of at least 250 Wh/kg. In another embodiment, the high-energy battery pack 16 may have a specific energy density of at least 300 Wh/kg. In another embodiment, the high-energy battery pack 16 may have a specific energy density of at least 400 Wh/kg. In one embodiment, the high-energy battery pack 16 may have a specific energy density of between 175 to 400 Wh/kg. In another embodiment, the high-energy battery pack 16 may have a specific energy density of between 250 to 400 Wh/kg.

With reference to FIGS. 2A-2C, example graphs indicating total power requested 30 (FIG. 2A) by the vehicle 12, power provided by the high-power battery pack 32 (FIG. 2B), and power provided by the high-energy battery pack 34 are shown (FIG. 2C). As shown in FIG. 2A, the total power requested over time by the vehicle 12 in this embodiment is up to about 75 kW. As shown in FIG. 2B, the high-power battery pack 14 provides a majority of the power, particularly during spikes in requested power. As shown in FIG. 2C, the power provided by the high-energy battery pack 16 is more consistent and does not exceed about 20 kW.

In at least one embodiment, the high-power battery pack 14 may receive a majority (e.g. over half) of the instantaneous regenerative energy generated during braking. In one embodiment, the high-power battery pack 14 receives at least 70% of the instantaneous energy generated during braking. In another embodiment, the high-power battery pack 14 receives at least 80% of the instantaneous energy generated during braking. In another embodiment, the high-power battery pack 14 receives at least 90% of the instantaneous energy generated during braking. In another embodiment, the high-power battery pack 14 receives substantially all of the instantaneous energy generated during braking. By having the high-power battery pack 14 receive a majority of the instantaneous regenerative braking energy; the high-energy battery pack 16 can have reduced instantaneous charge-acceptance requirements. As the battery packs 14, 16 are in parallel, the energies will be balanced as the current reduces (i.e. the HPBP 14 will charge the HEBP 16).

By having two separate batteries, a high-power battery pack 14 and a high-energy battery pack 16, the battery system 10 can be configured such that each battery pack is specifically designed for its specific task. In at least one embodiment, the high-power battery pack 14 is smaller than the high-energy battery pack 16. The size differentiation and specialization of the two battery packs helps in thermal management of the batteries. Since high power usage generates excess heat compared to lower power usage, the high-power battery pack 14 will have more eccentric heat production than the high-energy battery pack 16. However, due to its smaller size, the heat from the high-power battery pack 14 can be removed more quickly and efficiently, which also contributes to the battery life. As a result of reduced power spikes and fluctuation, the high-energy battery pack 16 can have a simplified design, particularly for thermal management.

In addition to thermal management benefits, various other benefits are achieved through the dual battery system 10. A reduction in the power requirements of the high-energy battery pack 16 can provide substantial cost savings for manufacturing expensive high capacity batteries. The transfer of the bulk of the transient high-power actions to the smaller high-power battery pack 14 significantly reduces the amount of high-power regenerative and discharge pulses undergone by the high-energy battery pack 16, which will extend the lifetime of the more expensive high-energy battery pack 16. Furthermore, since conventional HEV Li-ion battery packs have relatively high P/E ratios, existing battery packs may be suitable as the high-power battery pack 14, thereby saving on costs. Also, in the event of an emergency in which one of the battery packs fails, the failing battery pack can be taken offline and the remaining battery pack could allow the driver of the vehicle 12 to drive for a certain number of miles by providing all or substantially all of the battery propulsive power.

Having a dedicated high-power battery pack 14 also allows for increased recovery from regenerative braking. In conventional battery systems, the regenerative power is limited to a conservative/moderate level below the maximum level in order to avoid damage to the battery pack from high recharge pulses. This reduces the amount of energy that can be recovered and lowers the vehicle's “fuel economy.” However, with the inclusion of a high-power battery pack 14 designed to handle high power pulses, the battery system 10 can accommodate a higher level of regenerative power that is closer to the maximum level, thereby improving the vehicle's efficiency.

Cold weather performance is also improved with the dual battery pack system 10. At low temperatures, higher energy battery packs are particularly stressed due to their intrinsic design features, such as a low P/E ratio, thicker/denser electrodes, and a higher thermal mass. These design factors generally result in longer transport paths for ions and electrons. However, smaller and lower capacity battery packs have been shown to provide high power at cold temperatures. Since the smaller, high-power battery pack 14 provides a majority of the transient power demands in at least one embodiment of the battery system 10, low-temperature performance is improved.

The two battery packs 14, 16 may have the same or similar general chemistry (i.e. similar electrolyte and active electrode materials), but may be configured or constructed with different chemistries to meet their specific function (i.e. high power or high energy). Properties and characteristics that can be individually tailored include, but are not limited to, electrode materials, cell constituents in different cell formats (e.g. cell configuration, dimensions, electrode design, current collection strategy, and cell count), thermal management hardware and methods, and battery management systems (BMS).

With reference to FIG. 3, a simplified cross-section of a Li-ion cell 40 suitable for use in the high-power and high-energy battery packs 14, 16 is provided. The Li-ion cell 40 includes an electrolyte 42, positive electrode (cathode) 44, and negative electrode (anode) 46. Attached to the cathode 44 and anode 46 are current collectors 48 and 49 respectively. A separator 50 is disposed between the cathode 44 and anode 46.

The battery packs 14, 16 include an electrolyte 42 which may be a liquid electrolyte. Liquid electrolytes that may be suitable for the battery packs include various lithium salts, such as LiPF₆, LiBF₄ or LiClO₄ in an organic solvent, such as ethylene carbonate, dimethyl carbonate, and diethyl carbonate. In at least one embodiment, the high-power battery pack 14 and the high-energy battery pack 16 include the same electrolyte 42. As shown in FIG. 3, the electrolyte 42 is present within the cathode 44, anode 46, and separator 50.

Various types of positive electrode 44 materials and their suitability in either high-power, high-energy, or both of the battery packs in the battery system 10 are shown in Table 1, below. The exclusion of a type of electrode material from a certain type of battery pack does not indicate that the type may not be used, but merely is an indication that the properties may not be best suited to that type of battery pack. With reference to Table 1, types of electrodes that may be best suited for the positive electrode 44 of the high-power battery pack 14 include lithium nickel cobalt aluminum oxide (NCA), lithium nickel manganese cobalt oxide (NMC), lithium manganese spinel oxide (Mn Spinel or LMO), and lithium iron phosphate (LFP) and its derivatives lithium mixed metal phosphate (LFMP). In addition, mixtures of any of two or more of these materials may be used, for example a mixture of NMC and LMO.

The types of electrodes that may be best suited for the positive electrode 44 of the high-energy battery pack 16 include NCA, NMC, LMO, layered-layered, LFP/LFMP, and a mixture of two or more thereof. Certain types of positive electrodes 44 may be used advantageously in either high-power or high-energy batteries, such as NCA, NMC, LMO, LFP/LFMP, and mixtures of two or more thereof. The stoichiometric ratios of the various electrode types can be tailored to either high-energy or high-power batteries. For example, in an NMC electrode, the ratios of nickel, cobalt, and manganese can be tailored to be better suited for a high-energy or high-power application. The standard ratio of 1:1:1 can be used in either application, but increasing the relative nickel content can be particularly advantageous for high-energy applications. The afore-mentioned types of electrodes are known in the art, and will not be discussed individually in further detail.

TABLE 1
Various types of positive electrode materials and their suitability
in either high-power, high-energy, or both of the battery packs.

| POSITIVE ACTIVE MATERIAL | POWER | ENERGY | BOTH |
|---|---|---|---|
| NCA | ✓ | ✓ | ✓ |
| NMC | ✓ | ✓ | ✓ |
| Mn Spinel LMO | ✓ | ✓ | ✓ |
| Layered-layered | | ✓ | |
| LFP and LFMP | ✓ | ✓ | ✓ |
| Mixtures of 2 or More | ✓ | ✓ | ✓ |

Various types of negative electrode 46 materials and their suitability in either high-power, high-energy, or both of the battery packs in the battery system 10 are shown in Table 2 below. The exclusion of a type of electrode material from a certain type of battery pack does not indicate that the type may not be used, but merely is an indication that the properties may not be best suited to that type of battery pack. With reference to Table 2, types of electrodes that may be best suited for the negative electrode 46 of the high-power battery pack 14 include graphite (natural, artificial, or surface-modified natural), hard carbon, soft carbon, and lithium titanate oxide (LTO). The types of electrodes that may be best suited for the negative electrode 46 of the high-energy battery pack 16 include graphite (natural, artificial, or surface-modified), hard carbon, soft carbon, and silicon or tin-enriched graphite or carbonaceous compounds. Certain types of negative electrodes 46 may be used advantageously in either high-power or high-energy batteries, such as graphite (natural, artificial, or surface-modified natural), hard carbon, and soft carbon. The afore-mentioned types of electrodes are known in the art, and will not be discussed individually in further detail.

TABLE 2
Various types of negative electrode materials and their suitability
in either high-power, high-energy, or both of the battery packs.

| NEGATIVE ACTIVE MATERIAL | POWER | ENERGY | BOTH |
|---|---|---|---|
| Graphite (natural, artificial, surface- | ✓ | ✓ | ✓ |
| modified natural) | | | |
| Hard Carbon | ✓ | ✓ | ✓ |
| Soft Carbon | ✓ | ✓ | ✓ |
| Silicon or tin-enriched graphite or | | ✓ | |
| carbonaceous compounds | | | |
| LTO | ✓ | | |

In one embodiment, the high-power battery pack 14 and the high-energy battery pack 16 have the same positive electrode 44 type, which may comprise an NCA, NMC, LMO, LFP/LFMP, or a mixture thereof. In another embodiment, the high-power battery pack 14 and the high-energy battery pack 16 have the same negative electrode 46 type, which may comprise a graphite, hard carbon, or soft carbon type electrode. In one embodiment, the high-power battery pack 14 and the high-energy battery pack 16 have the same positive and negative electrode types. In another embodiment, the high-power battery pack 14 and the high-energy battery pack 16 have different positive and different negative electrode types.

In at least one embodiment, the high-power battery pack 14 comprises a 10 amp-hour (Ah), 86-cell unit and the high-energy battery pack 16 comprises a 100 Ah, 86-cell unit. However, it is not necessary that the cell count for each pack be the same. In one embodiment, the high-power battery pack 14 has a positive electrode 44 selected from the group of NCA, NMC, LMO, LFP/LFMP, and mixtures of two or more thereof and a negative electrode selected from the group of graphite, hard carbon, soft carbon, and LTO. The high-energy battery pack 16 has a positive electrode selected from NCA, NMC, LMO, layered-layered, LFP/LFMP, and mixtures of two or more thereof and a negative electrode selected from the group of graphite, hard carbon, soft carbon, and Si or Sn-enriched graphite or other carbonaceous compounds.

For example, the high-power battery pack 14 may have a NMC type positive electrode and a graphite type negative electrode 46 and the high-energy battery pack 16 may have a NMC type positive electrode 44 and a graphite type negative electrode 46. In this embodiment, the high-power battery pack 14 and the high-energy battery pack 16 use an electrolyte comprising LiPF₆ lithium salt and ethylene carbonate organic solvent.

In another example, the HPBP 14 may have a NMC/LMO type positive electrode 44 and a graphite type negative electrode 46 and the high-energy battery pack 16 may have a layered-layered type positive electrode 44 and a graphite type negative electrode 46. In this embodiment, the high-power battery pack 14 and the high-energy battery pack 16 use an electrolyte comprising LiPF₆ lithium salt and dimethyl carbonate organic solvent. However, it is to be understood that these are non-limiting examples and that all combinations of the above positive and negative electrode types and electrolytes are contemplated.

With respect to FIG. 4, a controls architecture for the dual-battery system is provided. Conventional wisdom has previously been that mixing of two batteries of different sizes or types should be avoided. However, the controls architecture described herein allows for this conventional restriction to be removed. The high-power battery pack 14 and high energy battery pack 16 are shown as strings 60, 62 of battery cells connected in series. The strings 60, 62 are connected in parallel and can be electrically isolated from one another by a first set of contactors 64, which may be on the positive or negative terminal of the batteries. In some embodiments, each battery may have a second set of contactors 65. In one embodiment, each string contains therein multiple cells of the same size and type. One or more Battery Pack Sensor Modules (BPSM) 66 may be provided to manage sensing, cell balancing, and input/output (I/O) of at least one of the strings 60, 62. However, these functions could also be provided by one or both of the BECMs 18, 20 or another controller. When present, the BPSM 66 may be connected to the BECMs 18 and/or 20 by a communications network, for example a Controller Area Network (CAN). A second set of contactors 68 may optionally be provided on the vehicle side of the strings 60, 62. The second set of contactors 68 may comprise a contactor 68 on each string or a single contactor 68 on the vehicle side of the parallel point.

Since the HPBP 14 and the HEBP 16 are in parallel, the voltages must match in order to avoid the pack with the higher voltage charging the pack with the lower voltage until they match. The range of operating voltage of the packs 14, 16 is from the greater of the two packs' minimum voltages to the lesser of the two packs' maximum voltages. In addition, the discharge and charge in and out of the battery packs 14, 16 should be limited so that the voltage of the battery pack, the cell voltages, and the voltage of the system 10 are within appropriate ranges. Furthermore, current in and out of the battery packs may need to be limited to protect the cells and the high voltage wiring. Power and/or current may be limited in order to extend battery life and/or maintain a consistent drivability “feel” for the driver.

In general, the process for controlling the battery system 10 includes determining the power capability of each string 60, 62, adjusting the power capability based on the reason for the power limitation, adjusting both strings 60, 62 such that the power capability is determined at the same voltage, and adding the power capabilities together. The limiting voltage is generally the less extreme of the two (e.g. the higher of the two minimum voltages) and which string 60, 62 is the limiting string can potentially change during operation. Determining the power capability of a single battery has been described in U.S. Publication No. 2012/0179435 A1 published Jul. 12, 2012, which is hereby incorporated by reference in its entirety. FIG. 5 shows an algorithm 70 illustrating an algorithm in accordance with embodiments of the present invention.

At step 72, a number of battery parameters are measured for each battery 14, 16, such as voltage (v), current (i) and temperature (T). Values for these parameters are passed to an equivalent circuit identification at step 74. In addition to the battery parameters determined at step 72, additional battery control processes can be determined at step 76, and values passed to the equivalent circuit identification at step 74, or, for example, step 78, where the battery power capability is determined. In the embodiment shown FIG. 5, the state of charge (SOC) is used by the equivalent circuit identification step 74, and in particular may be used to determine an open circuit voltage.

The discharge and charge current and voltage limits as indicated by (Vₗᵢₘ) and (Iₗᵢₘ) can be used in step 78 during a battery power capability determination. The value of Vₗᵢₘ may represent, for example, vₘᵢₙ or vₘₐₓ, and likewise, Iₗᵢₘ may represent, for example, iₘᵢₙ or iₘₐₓ. The output from step 78 is the battery power capability, indicated by (P_{cap}), of each battery 14, 16 which can be a discharge or charge capability. In step 80, the minimum voltages of battery packs 14, 16 are compared. If they are equal, then the total power capability of the battery system 10 is calculated in step 82 as the sum of the two power capabilities (P_{cap14} and P_{cap16}). If the minimum voltages are not equal, then in step 84 the power capability of the battery pack with the lower minimum voltage is recalculated using the minimum voltage of the other battery pack (the limiting pack voltage). The total power capability of the battery system 10 is then calculated as the sum of the two power capabilities at the higher minimum voltage.

The pack power capability may be limited by the maximum current that a cell can handle, in order to ensure that no cell is over-charged or over-discharged. This is done by using existing methods to determine the maximum current that a cell can handle and calculating the pack power capability at that current. The actual power limit of the system 10 may be less that the total power capability for several reasons: in order to avoid exceeding current and/or voltage limits of either string 60, 62; because the power capability is more than the vehicle can use; the presence of faults in the system; and due to a chosen operating mode, for example.

In the above embodiments, determining the power and current limits for charging (instead of discharging) are determined using the same processes, except that the limiting voltage used is always the lower of the two and “maximum cell voltage” replaces “minimum cell voltage.”

Although the voltage of the two strings 60, 62 will be the same, the SOC is not necessarily the same. Cell balancing in the strings 60, 62 can be accomplished by the BECM 18 (and/or BECM 20) as described previously, and is generally done during charging. Cell balancing is beneficial in the battery system 10 for several reasons, for example cell balancing in the HEBP 16 helps to enhance battery life. In addition, minimizing cell imbalance provides the highest possible travel range for the vehicle 12, particularly in BEVs and vehicles operating in electric-only modes.

In at least one embodiment, the battery packs 14, 16 operate at a range within the middle of the SOC, for example from 5 to 99 percent. In another embodiment, the battery packs 14, 16 operate at a range within the middle of the SOC from 10 to 95 percent. The HPBP 14 should provide adequate discharge power over its entire operating range. In at least one embodiment, the HPBP 14 and the HEBP 16 operate over substantially the same SOC range. In other embodiments, they may operate over different SOC ranges. Typically, only one SOC is broadcast to the vehicle 12 for display, so in embodiments where the battery packs 14, 16 operate over different SOC ranges one must be selected for broadcast. In BEVs, the HEBP 16 SOC should be chosen because it determines the vehicle range. In a PHEV, the HEBP 16 SOC will typically also be chosen for all-electric range. In some embodiments, a SOC is broadcast or displayed in the vehicle that is not identical to the actual SOC, but is based on the SOC of one of the batteries (e.g. the HEBP 16). This may be done for several reasons. First, similar to a gas tank, it is beneficial to have a reserve such that when the range of an electric vehicle shows “0” in the vehicle there is actually some charge left in reserve. Second, at the low end of the SOC, the battery power may not be sufficient to fully or adequately power the vehicle. Similarly, the battery is not always charged to a true 100% SOC, so it may be advantageous to display a SOC of 100% in the vehicle at a pre-determined level below 100% so that the user knows it's charged to the intended maximum value (e.g. 95%).

In the dual-battery system 10, the battery packs 14, 16 should be charge compatible, in that they use the same charge algorithm and have the same, or very similar, maximum charging voltages. The battery packs 14, 16 should be able to be successfully operated after being charged with the same charge algorithm, to the same maximum pack voltage. However, both battery packs do not have to be at 100% SOC following the charging, one or both may be not fully charged. The charge algorithm should first determine the desired or maximum string voltage and current for each string 60, 62. The maximum voltage is the lower of the two voltages. It may be necessary to limit current in a manner similar to the limits on power capability discussed above, in order to avoid excessive current on the battery.

Contactor control for a dual-battery system is more complex than for single battery systems, for which the only concern is typically closing the contactors. In at least one embodiment, the contactors 64 are closed one at a time in order to avoid high current draws. While driving, the following processes should generally be followed. When the contactors 64 are ready to be closed, they are closed one at a time. If one string is at a higher voltage than the other, it should be closed first. If the open circuit voltage between the strings 60, 62 is significant then a high-current pulse could occur when the second string is closed, which could harm the system 10. The magnitude of the current pulse may be approximated by the equation: I_pulse=(V₂−V₁)/(R₁+R₂), wherein Vₙ and Rₙ are the string voltage and resistance of pack n, respectively and the sign of the current signifies the direction of current flow. If, for example, the HEBP 16 was at a voltage of 200V and had a resistance of 0.1 ohms and the HPBP 14 was at a voltage of 185V and a resistance of 0.05 ohms, then the pulse current would be approximately 100 amps.

A solution to this issue in one embodiment is to have a pre-charge contactor 90 on each string 60, 62, which would be used if the voltages of the strings are more than a certain amount apart. The pre-charge contactors 90 are in parallel with contactors 64. In another embodiment, the contactor for the higher voltage string may be closed first and the contactor for the other string is not closed until the battery has been discharged enough, or the current is high enough, to bring the voltages within an acceptable range.

If the voltages of the strings 60, 62 are significantly different before the contactors 64 are closed to charge the battery packs 14, 16 then a process should also be followed to prevent damage to the system 10. In one embodiment, the contactor 64 for the string at the lower voltage should be closed first. The battery is charged at an appropriate and safe rate until the voltage is within a tolerance of the voltage of the other, higher voltage, string. Once the voltage is within the tolerance, the contactor 64 for the higher voltage string may be closed and charging can proceed normally. In one embodiment, the charge current is kept low until the contactors 64 on both strings are closed, in order to minimize current pulses when the second contactor is closed. In some embodiments, an optional charge contactor can be utilized in parallel with contactor(s) 68.

Thermal management of the battery packs 14, 16 raises an issue unique to dual-battery systems, compared to single-battery systems, and particularly when the batteries have different capacities and functions. As discussed previously, in at least one embodiment of the battery system 10, the HPBP 14 has a smaller capacity and is smaller in size than that HEBP 16. Due to the greater power generation, the HPBP 14 will have more temperature fluctuations and will rise in temperature faster than the HEBP 16.

In the dual-battery system 10, several constraints must be met. First, the voltages must be the same. Using a voltage/current relationship of V=V₁−IR, that means that V_{0,1}−I₁R₁=V_{0,2}−I₂R₂. In general, I₁R₁≅I₂R₂ based on the state of charge imbalance between the two strings and the definition of resistance in a nonlinear battery. In order to maintain equal string voltages, the net charge removed from each string 60, 62 must, over time, be equal relative to the capacity (Q) of each string:

$$\int \frac{{I}_{1} d t}{{Q}_{1 }} = \int \frac{{I}_{2} d t}{{Q}_{2}} .$$

However, ohmic heat generation is proportional to the product of the square of the current: H_{gen}=∫I²R dt. Therefore, the corresponding temperature rise, if no heat is removed, can be represented as

$$Δ T = \int \frac{{I}^{2} R}{{mC}_{p}} d t ,$$

where “m” is the mass of the cell and “Cₚ” is the heat capacity. For many similar cells, the total heat capacity (mCₚ) is proportional to the cell capacity, so if mCₚ=kQ then the relationship can be stated as

$$Δ T = \int \frac{{I}^{2} R}{kQ} d t .$$

If the same heating rate was to be maintained for each battery pack, then the I²R term must be proportional to cell capacity. In addition, in order to maintain charge balance, the current term must also be proportional to cell capacity. Accordingly, the following relationship would have to hold to maintain the same rate of temperature increase: Q₁R₁=Q₂R₂. However, this would be detrimental to the concept of having separate and specialized high-power and high-energy batteries. If the batteries are specialized as described previously, for example the HEBP 16 has a capacity twenty times higher than the HPBP 14, or Q₁=20Q₂, and the internal resistances are approximately equal, R₁=R₂, then the temperature of the HPBP 14 will rise about twenty times faster than the HEBP 16.

To address the difference in heating rates of the two battery packs 14, 16, there are several possible cooling solutions. In one embodiment, each battery pack is provided with a dedicated, independent cooling loop. In another embodiment, a single cooling system is provided to cool both battery packs and keep them both in a desired range. The smaller size of the HPBP 14 aids in the cooling due to an increased surface area to volume ratio compared to the HEBP 16. Instead of, or in addition to, liquid cooling, air cooling of one or both of battery packs 14, 16 may be used. Alternatively, in some embodiments no active cooling may be required if passive cooling is sufficient.

Other potential issues in a dual-battery system 10 are leakage detection and voltage and current synchronization and latency. For leakage detection, the measurement points must be located such that the isolation between the battery packs and the chassis can be determined in any operating mode of the battery. In one embodiment, two measurement circuits are provided, one for each battery pack 14, 16. In another embodiment, a single circuit is provided having sensors positioned such that the isolation can be determined.

For voltage and current synchronization and latency, the current of each string 60, 62 must be measured, and the voltage of the battery system 10 and the current output of the battery system 10 to the vehicle controls must be synchronized such that the vehicle controls know the actual power being provided from and accepted by the batteries. Since there are two strings 60, 62, the current of each must be measured. In one embodiment, the measurement is done by placing a sensor on each string. In another embodiment, the measurement is done by placing a sensor on one string and another on the combined output. In another embodiment, three sensors are used, one on each string and one on the combined output.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic data tape storage, optical data tape storage, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers, or any other hardware components or devices, or a combination of hardware, software and firmware components.

While the best mode has been described in detail, those familiar with the art will recognize various alternative designs and embodiments within the scope of the following claims. Additionally, the features of various implementing embodiments may be combined to form further embodiments of the invention. While various embodiments may have been described as providing advantages or being preferred over other embodiments or prior art implementations with respect to one or more desired characteristics, those of ordinary skill in the art will recognize that one or more features or characteristics may be compromised to achieve desired system attributes, which depend on the specific application and implementation. These attributes may include, but are not limited to: cost, strength, durability, life cycle cost, marketability, appearance, packaging, size, serviceability, weight, manufacturability, ease of assembly, etc. The embodiments described herein that are described as less desirable than other embodiments or prior art implementations with respect to one or more characteristics are not outside the scope of the disclosure and may be desirable for particular applications. Additionally, the features of various implementing embodiments may be combined to form further embodiments of the invention.

What is claimed is:

1. A battery system for powering a vehicle, comprising:
a first lithium-ion battery pack having a first total energy capacity and a first power to energy ratio (P/E ratio);
a second lithium-ion battery pack connected in parallel with the first lithium-ion battery pack and having a second total energy capacity that is higher than the first total energy capacity and a second P/E ratio that is lower than the first P/E ratio; and
at least one controller programmed to control the first and second lithium-ion battery packs.

2. The battery system of claim 1, wherein the first P/E ratio is at least 15 kW/kWh and the second P/E ratio is no more than 10 kW/kWh.

3. The battery system of claim 1, wherein the at least one controller is programmed to provide more than half of an electric transient power demand of the vehicle from the first lithium-ion battery pack.

4. The battery system of claim 1, wherein the second lithium-ion battery pack has a total energy capacity of at least 20 kWh.

5. The battery system of claim 1, wherein the second lithium-ion battery pack has a specific energy density of at least 175 Wh/kg.

6. The battery system of claim 1, wherein the first lithium-ion battery pack has a type of positive electrode selected from the group consisting of lithium nickel cobalt aluminum oxide (NCA), lithium nickel manganese cobalt oxide (NMC), lithium manganese spinel oxide (Mn Spinel), lithium iron phosphate (LFP), lithium mixed metal phosphate (LFMP), and mixtures thereof and the second lithium-ion battery pack has a positive electrode selected from the group consisting of NCA, NMC, MN Spinel, layered-layered, LFP, LMFP, and mixtures thereof.

7. The battery system of claim 1, wherein the first lithium-ion battery pack has a type of negative electrode selected from the group consisting of graphite, hard carbon, soft carbon, and lithium titanate oxide (LTO) and the second lithium-ion battery pack has a negative electrode selected from the group consisting of graphite, hard carbon, soft carbon, Si-enriched graphite, and Sn-enriched graphite.

8. The battery system of claim 6, wherein the first lithium-ion battery pack and the second lithium-ion battery pack have the same type of positive electrodes.

9. The battery system of claim 6, wherein the first lithium-ion battery pack and the second lithium-ion battery pack have different types of positive electrodes.

10. The battery system of claim 7, wherein the first lithium-ion battery pack and the second lithium-ion battery pack have different types of negative electrodes.

11. A method for operating a vehicle, comprising:
receiving in a vehicle controller information corresponding to limiting voltages of a first and a second lithium-ion battery string, each battery string having different total energy capacity; and
controlling an operation of the vehicle according to a total power capability of the first and second battery strings;
wherein the total power capability is the sum of a first battery string power capability and a second battery string power capability at a same voltage.

12. The method of claim 11, wherein the operation is a discharge of the first and second battery strings and the same voltage is a voltage corresponding to a higher of a minimum voltage of the first battery string and a minimum voltage of the second battery string.

13. The method of claim 11, wherein the operation is a charge of the first and second battery strings and the same voltage is a voltage corresponding to a lower of a maximum voltage of the first battery string and a maximum voltage of the second battery string.

14. The method of claim 11, wherein the first battery string and the second battery string operate over different state of charge (SOC) ranges.

15. The method of claim 11, wherein a SOC is communicated to a vehicle display based on a SOC of the battery string having a higher total energy capacity.

16. The method of claim 11 further comprising controlling operation of the vehicle such that over half of an electric transient power demand of the vehicle is provided by the battery string having a lower total energy capacity.

17. The method of claim 11 further comprising controlling operation of the vehicle such that over half of instantaneous energy generated during braking is received by the battery string having a lower total energy capacity.

18. The method of claim 11 further comprising controlling operation of the vehicle such that if one battery string fails it is taken offline and the other battery string provides substantially all propulsive battery power to the vehicle.
